(19) United States
(12) Patent Application Publication
(10) Pub. No.: US 2022/0105368 A1
(43) Pub. Date: Apr. 7, 2022

(54) K9 Quick-Clip Oxygen Muzzle

(71) Applicant: Thomas Kenney Barrett, JR., Midlothian, VA (US)

(72) Inventor: Thomas Kenney Barrett, JR., Midlothian, VA (US)

(21) Appl. No.: 17/550,752

(22) Filed: Dec. 14, 2021

Related U.S. Application Data
(63) Continuation-in-part of application No. 16/292,558, filed on Jul. 25, 2019.

(51) Int. Cl. A62B 18/06; A01K 25/00

(52) U.S. Cl. CPC A62B 18/06; A01K 25/00

(57) ABSTRACT

A dual-purpose muzzle is capable of protecting the canine handler from a bite while providing lifesaving oxygen to a canine in distress. The muzzle is designed to clip behind the head like a soft muzzle while delivering needed oxygen with its internal oxygen tubing and specially designed port for quick hook up. The port allows for any standard EMS tubing to connect to the muzzle. This allows for a continuous flow of oxygen directed to the snout and mouth of the canine allowing the handler to be hands free to address any other emergencies.

### REFERENCE TO RELATED APPLICATIONS

This is a continuation-in-part application claiming the priority of non-provisional application Ser. No. 16/292,558 filed Jul. 25, 2019 titled K9 Quick Clip Oxygen Muzzle which claims the priority of provisional application 62/761,047 filed on Mar. 5, 2018 titled K9 Quick Clip Oxygen Muzzle.

### BACKGROUND OF THE INVENTION

This invention relates generally to oxygen therapy for canines and, more particularly, to an oxygen muzzle configured to quickly attach/clip to a dog's snout. In other words, this invention supplies rapid oxygen therapy to a service dog.

As canines have become more involved in military roles, law enforcement and search and rescue roles, a greater emphasis on medical procedures has been experienced. Medical protocols have been implemented to deal with more frequent emergencies. In the same manner humans do, canines require sufficient and constant supplies of oxygen to survive. When serving in the military or law enforcement, canines may find themselves in remote areas where there need of rapid oxygen therapy is simply not available. There is one known item used for oxygen therapy for canines in an urban environment but not in a working field environment. It is a hard plastic cone with a hook up. It is not compactable nor flexible. Although various devices have been proposed for supplying oxygen to canines via a muzzle, there is still a need for innovation in administering oxygen therapy quickly and easily to a dog in distress.

Therefore, it would be desirable to have a dual-purpose muzzle capable of protecting the canine handler from a bite while providing lifesaving oxygen to a canine in distress. Further, it would be desirable to have a dual-purpose muzzle having a quick connect construction for positioning on the nose or snout of a dog.

### SUMMARY OF THE INVENTION

Accordingly, a quick action oxygen muzzle for providing oxygen therapy to a canine according to the present invention includes a muzzle having a nose portion adjacent and connected to an adjustment portion, the muzzle having a conical configuration defining an open end for receiving a snout of the canine, the nose portion being constructed of an opaque, non-permeable material that is flexible and the adjustment portion being constructed of a permeable webbing that is flexible, the adjustment portion defining the open end. The oxygen muzzle includes a length of tubing having an elongate configuration for gaseous transmission, the tubing having a proximal end proximate an interior area defined by the nose portion and a distal end displaced and extended away from the proximal end. The proximal end of the tubing includes at least one outlet port through which oxygen is selectively expelled. Further, pouch is coupled to the distal end of the tubing, the receptacle defining an interior space. An oxygen container is situated in the interior space of the receptacle and in fluid communication with the tubing so as to push oxygen toward the at least one outlet port when actuated. A harness system for holding the muzzle to the canine and for selectively attaching the receptacle to the canine.

Therefore, a general object of this invention is to provide an oxygen muzzle that may be rapidly and easily administered to a canine.

Another object of this invention is to provide an oxygen muzzle, as aforesaid, that clips behind the head of the canine like a soft muzzle having internal tubing and a port for fast hook up to an oxygen source, such as may be provided by an Emergency Medical Service (EMS) provider.

A further object of this invention is to provide an oxygen muzzle, as aforesaid, that includes highly durable webbing so as to be lightweight and tactical.

A still further object of this invention is to provide an oxygen muzzle, as aforesaid, that is portable, lightweight, and may be folded and stowed.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1a is a perspective view a muzzle of an oxygen muzzle according to a preferred embodiment of the present invention, said snout portion being shown with an adjustment portion in a fully extended configuration;

FIG. 1b is a perspective view of the muzzle as in FIG. 1a, illustrated with an adjustment portion in a partially compressed configuration;

FIG. 2a is a perspective view of the oxygen muzzle as in FIG. 1a operatively coupled to an oxygen reservoir coupled to a pet collar;

FIG. 2b is a perspective view of the oxygen muzzle as in FIG. 2a being worn by a canine to provide context;

FIG. 2c is a perspective view of the oxygen muzzle as in FIG. 2b according to another embodiment of the present invention; and

FIG. 3 is a perspective view of an oxygen muzzle according to another embodiment of the present invention, illustrated with a full harness system strapped to a canine.

### DESCRIPTION OF THE PREFERRED EMBODIMENT

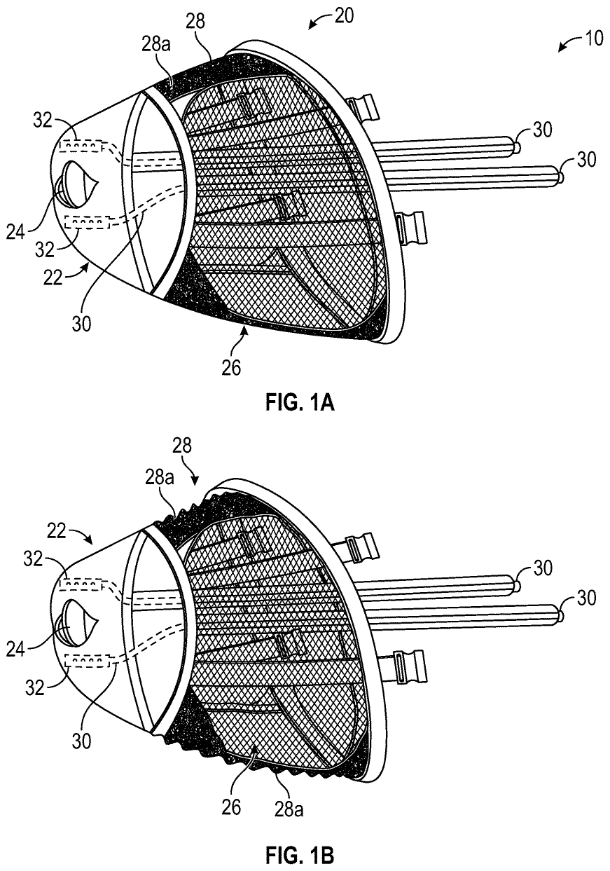

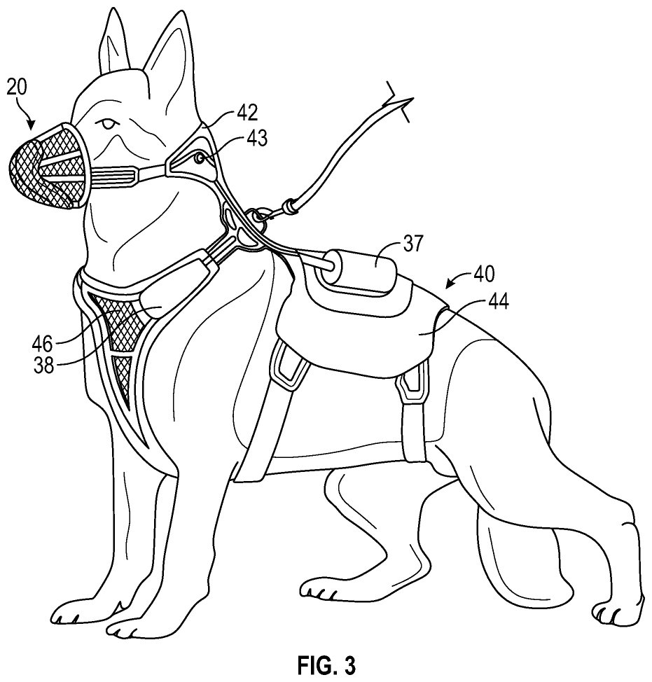

A K9 quick clip oxygen muzzle according to a preferred embodiment of the present invention will now be described with reference to FIG. 1a to 3 of the accompanying drawings.

The oxygen muzzle 10 includes a construction that makes it conducive to be collapsed and folded for stowage when not in use, such as would enable the muzzle 10 to be carried in a person's pocket so as to be available if a user accompanies a canine on a military or law enforcement mission that takes them far away from veterinary care. More particularly, the oxygen muzzle 10 includes a muzzle 20 having a nose portion 22 connected to an adjustment portion 26. The nose portion 22 has a rounded front end and an open rear edge to which a front edge of the adjustment portion 26 is coupled such as by stitching. Together, the nose portion 22 and adjustment portion 26 of the muzzle 20 have a conical configuration defining an interior area, a rear edge of the adjustment portion 26 defining an opening sufficient for receiving a snout (nose) of a canine into the interior area.

In a critical aspect, the nose portion 22 is constructed of a flexible or semi-flexible material that is, preferably, opaque and nonpermeable. Further, the adjustment portion 26 may be constructed of a permeable webbing that also is flexible or semi-flexible and, therefore, foldable. Together, the nose and adjustment portions have a conical configuration when deployed. In addition, the adjustment portion 26 is movable between a collapsed configuration or partially collapsed configuration more adjacent or more proximate the nose portion 22 (FIG. 1b) and an extended or deployed configuration extending rearwardly and away from the nose portion 22 (FIG. 1a). Further, a size adjustment strap 28 is coupled to the adjustment portion 26 and extends between a rear edge of the nose portion 22 and the open end of the adjustment portion 26. In an embodiment, the adjustment strap 28 may be a length of fabric or other flexible material. Importantly, the size adjustment strap 28 includes a plurality of hook and loop fasteners 28a) positioned such that the size adjustment strap 28 may be length adjustable. It is a user adjusting the length of the adjustment strap 28 that causes movement of the adjustment portion 26 between collapsed and extended configurations.

In an embodiment, the muzzle 20 may include a pair of straps each having a fastener such as a J-clip suitable for connection to an existing muzzle (FIG. 1). In other embodiments, the straps may include multiple additional straps and each may have an elongate or elastic construction and the fastener may include a buckle so as to be selectively fastened behind a head of the canine or the like.

In an aspect, the front end of the nose portion 22 may define or include a front port 24 configured for connection to an oxygen source such as may be provided for oxygen therapy. The front port 24 is situated proximate an at least one outlet port 32 situated proximate the front end of the nose portion 22.

In another aspect, the oxygen muzzle 10 includes a length of tubing 30 having an elongate configuration, said tubing 30 having a diameter so as to allow a gaseous stream, such as oxygen, to flow through the tubing 30. The tubing 30 includes a proximal end proximate and situated in an interior area defined by the nose portion 22. The proximal end includes at least one outlet port 32 and preferably a pair of spaced apart outlet ports situated in the interior area defined by the nose portion 22. In use, the outlet ports 32 will be proximate the nostrils of the canine when the muzzle 20 is situated over the snout of the canine as will discussed in more detail later. The at least one outlet port 32 is configured to release oxygen being pushed through the tubing 30 to be inhaled by the canine.

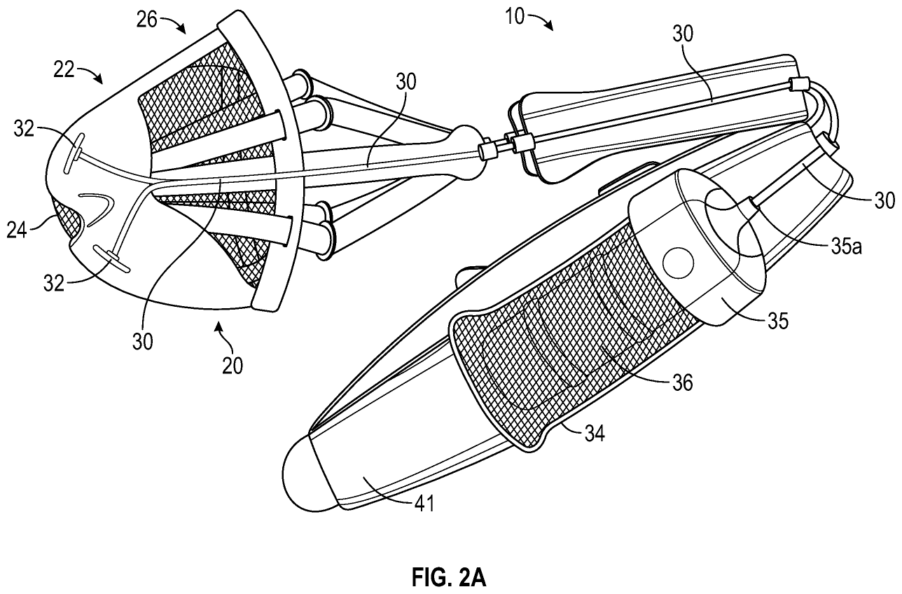

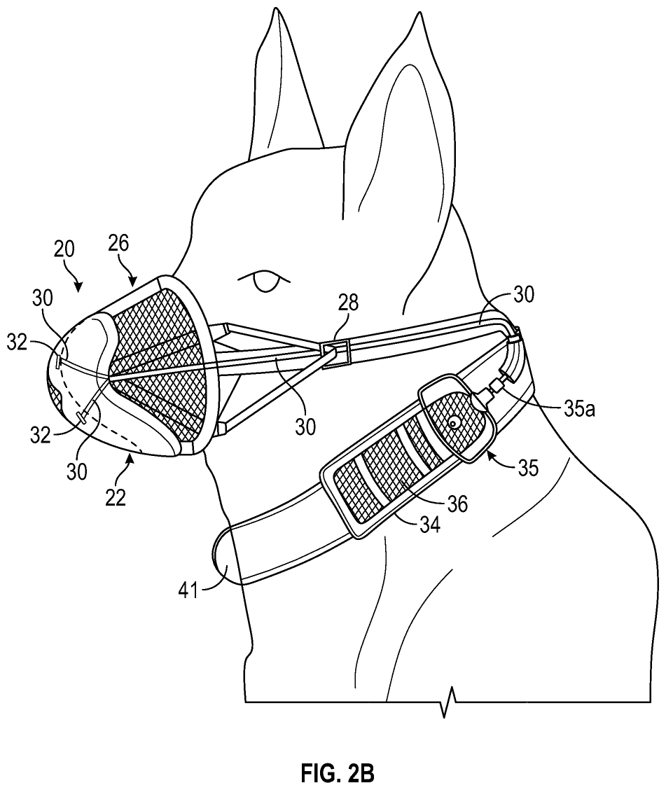

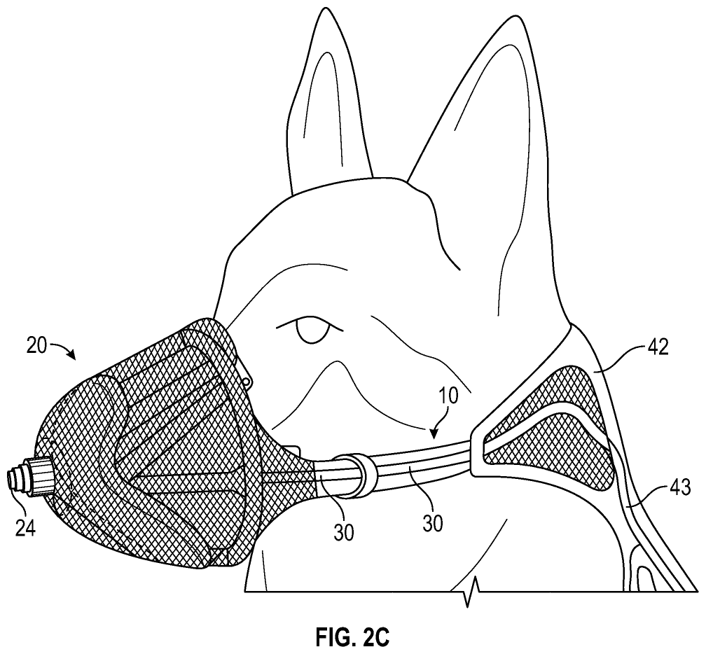

Still further, the oxygen muzzle 10 includes an oxygen reservoir 36 containing compressed oxygen. This oxygen reservoir 36 may also be referred to as a primary oxygen reservoir by contrast to auxiliary reservoirs to be described later. Preferably, the oxygen muzzle 10 also includes a receptacle 34 coupled to the distal end of the tubing 30, the receptacle 34 defining an interior space. (FIG. 2a). The receptacle 34 may be a pouch constructed of webbing material so that the receptacle 34 is partially transparent. The pouch may define an open top and may include a cap 35 that may be selectively attached to the open top whereby to prevent access to the interior space of the receptacle and the Primary oxygen reservoir 36. The cap 35 includes or defines a delivery port 35a operably coupled to the distal end of said tubing 30, the delivery port 35a being in fluid communication with the primary oxygen reservoir 36 such that oxygen from the primary oxygen reservoir 36 is pushed through the tubing 30 to the at least one outlet port 32 for inhalation by a canine when actuated.

In another aspect, the oxygen muzzle 10 includes a harness system 40 that may be coupled to the neck and body of a canine and to which oxygen canisters may be attached. In an embodiment, the harness system 40 may be a traditional collar 41 to which the primary oxygen receptacle 34 may be coupled (FIG. 2b).

In an embodiment, the harness system 40 may include a head strap 42 that is attached to opposed edges of the open end of the adjustment portion 26 via a head strap linkage. The head strap 42 enables the muzzle 20 to be held on the snout of a canine when positioned on the backside of the canine's head. It is understood that the tubing 30 extends through the head strap linkage and head strap 42 itself. Importantly, the head strap 42 may include or define at least one rear port 43 operably configured to receive and transmit oxygen from a source outside of the rear port 43 through the tubing 30 to the outlet port 32 during oxygen therapy to the canine.

In still another embodiment, the harness system 40 may include a full body harness having a saddle portion 44 and a chest harness portion 46—both of which may provide more oxygen supplies. More particularly, the saddle portion 44 may include a fabric or a pad dimensioned and configured to nest and rest upon the back of a canine's body. Further, the tubing 30 extends through or onto the saddle portion 44 where the tubing 30 is operably coupled to a first auxiliary reservoir 37 containing compressed oxygen which, when actuated, transmits oxygen through said tubing 30 to the at least one outlet port 32. Similarly, the harness system 40 includes the chest harness portion 46 which may then be positioned on the canine's chest and attached to at least one of a pair of straps associated with saddle portion 44 and also to the head strap 42. In addition, a second auxiliary reservoir 38 containing compressed oxygen may be coupled to the chest harness and in fluid communication with the tubing so as to push oxygen through the tubing 30 to the at least one outlet port 32 for additional oxygen therapy given to the canine.

In use, a canine's handler may desire to administer oxygen therapy to a canine, especially after an intense or lengthy task while still in the field of service and away from traditional veterinary care. In such case the oxygen muzzle 10 according to the present invention may be available for easy transport, fast connection to a canine's snout, and capable of quickly administering oxygen for inhalation by the canine. More particularly, the muzzle 20 may be unfolded, extended, and positioned on the snout of a canine and may be secured in that position by a harness system. Further, one or more oxygen reservoirs may be actuated (such as by turning a valve to an on position) so as to push oxygen through the tubing to the at least one outlet port 32 where it may be inhaled by the dog. When an oxygen therapy session is complete, the muzzle 10 may be folded and stowed until needed again.

It is understood that while certain forms of this invention have been illustrated and described, it is not limited thereto except insofar as such limitations are included in the following claims and allowable functional equivalents thereof.

1. A quick action oxygen muzzle for providing oxygen therapy to a canine, comprising:
a muzzle having a nose portion adjacent and connected to an adjustment portion, said muzzle having a conical configuration defining an open end for receiving a snout of the canine,
said nose portion being constructed of an opaque, non-permeable material that is flexible and said adjustment portion being constructed of a permeable webbing that is flexible, said adjustment portion defining said open end;
a length of tubing having an elongate configuration for gaseous transmission, said tubing having a proximal end proximate an interior area defined by said nose portion and a distal end displaced and extended away from said proximal end;
wherein said proximal end of said tubing includes at least one outlet port through which oxygen is selectively expelled;
a receptacle coupled to said distal end of said tubing, said receptacle defining an interior space;
an oxygen reservoir containing compressed oxygen situated in said interior space of said receptacle and in fluid communication with said tubing so as to push oxygen toward said at least one outlet port when actuated;
a harness system for holding said muzzle to the canine and for selectively attaching said receptacle to the canine.

2. The oxygen muzzle as in claim 1, wherein said nose portion includes a front port situated proximate said at least one outlet port that is operable to transmit oxygen from outside said nose portion into said interior area defined by said nose portion.

3. The oxygen muzzle as in claim 1, further comprising a size adjustment strap extending between a rear edge of said nose portion and said open end of said adjustment portion, said size adjustment strap including a plurality of hook and loop fasteners and is flexible so as to be move said adjustment portion between a collapsed configuration closely adjacent said nose portion and an extended configuration extending away from said nose portion.

4. The oxygen muzzle as in claim 1, further comprising a pair of attachment straps, wherein each attachment strap has a first end coupled to said muzzle and a second end extending rearwardly away from said first end and having a buckle, said pair of attachment straps being operable to attach said muzzle on the snout of the canine when said buckles are coupled about a neck of the canine.

5. The oxygen muzzle as in claim 1, wherein:
said reservoir is a pouch constructed of a webbing material and defining an open top through which said oxygen reservoir is selectively received into said interior space; and
said reservoir includes a cap selectively positioned to enclose said open top and prevent access to said interior space, said cap defining a delivery port in fluid communication with said oxygen reservoir and said distal end of said tubing.

6. The oxygen muzzle as in claim 1, wherein said harness system includes a collar configured to selectively extend about a neck of the canine, said receptacle being removably coupled to said collar.

7. The oxygen muzzle as in claim 1, wherein said harness system includes a head strap coupled to opposite edges of said open end of said adjustment portion of said muzzle via a head strap linkage such that said head strap is displaced from said muzzle, said tubing extending through said head strap.

8. The oxygen muzzle as in claim 7, wherein said head strap includes a rear port in fluid communication with said tubing and configured for transmitting oxygen from outside said head strap into said tubing.

9. The oxygen muzzle as in claim 9, wherein said harness system includes:
a saddle portion configured to nest on a back of the canine and having a pair of straps depending from said saddle portion for securement about an underbelly of the canine;
a chest harness portion coupled to at least one of said pair of straps of said saddle portion and to said head strap;
wherein said tubing extends through said saddle portion and said chest harness portion;
said oxygen muzzle including:
a first auxiliary reservoir containing oxygen coupled to said saddle portion and in fluid communication with said tubing so as to push oxygen toward said at least one outlet port when actuated;
a second auxiliary reservoir containing oxygen coupled to said chest harness portion and in fluid communication with said tubing so as to push oxygen toward said at least one outlet port when actuated.

10. The oxygen muzzle as in claim 9, wherein said tubing is enclosed in webbing for protection from external forces.

11. A quick action oxygen muzzle for providing oxygen therapy to a canine, comprising:
a muzzle having a nose portion adjacent and connected to an adjustment portion, said muzzle having a conical configuration defining an open end for receiving a snout of the canine,
said nose portion being constructed of an opaque, non-permeable material that is flexible and said adjustment portion being constructed of a permeable webbing that is flexible, said adjustment portion defining said open end;
a length of tubing having an elongate configuration for gaseous transmission, said tubing having a proximal end proximate an interior area defined by said nose portion and a distal end displaced and extended away from said proximal end;
wherein said proximal end of said tubing includes at least one outlet port through which oxygen is selectively expelled;
a receptacle coupled to said distal end of said tubing, said receptacle defining an interior space;
an oxygen reservoir containing compressed oxygen situated in an interior space of said receptacle and in fluid communication with said tubing so as to push oxygen toward said at least one outlet port when actuated;
wherein said reservoir is a pouch constructed of a webbing material and defining an open top through which said oxygen reservoir is selectively received into said interior space;
a harness system for holding said muzzle to the canine and for selectively attaching said receptacle to the canine;
wherein said nose portion includes a front port situated proximate said at least one outlet port that is operable to transmit oxygen from outside said nose portion into said interior area defined by said nose portion; and
a size adjustment strap extending between a rear edge of said nose portion and said open end of said adjustment portion, said size adjustment strap including a plurality of hook and loop fasteners and is flexible so as to be move said adjustment portion between a collapsed configuration closely adjacent said nose portion and an extended configuration extending away from said nose portion;
wherein said reservoir includes a cap selectively positioned to enclose said open top and prevent access to said interior space, said cap defining a delivery port in fluid communication with said oxygen reservoir and said distal end of said tubing.

12. The oxygen muzzle as in claim 11, wherein said harness system includes a collar configured to selectively extend about a neck of the canine, said receptacle being removably coupled to said collar.

13. The oxygen muzzle as in claim 11, wherein said harness system includes a head strap coupled to opposite edges of said open end of said adjustment portion of said muzzle via a head strap linkage such that said head strap is displaced from said muzzle, said tubing extending through said head strap.

14. The oxygen muzzle as in claim 13, wherein said head strap includes a rear port in fluid communication with said tubing and configured for transmitting oxygen from outside said head strap into said tubing.

15. The oxygen muzzle as in claim 14, wherein said harness system includes:
a saddle portion configured to nest on a back of the canine and having a pair of straps depending from said saddle portion for securement about an underbelly of the canine;
a chest harness portion coupled to at least one of said pair of straps of said saddle portion and to said head strap;
wherein said tubing extends through said saddle portion and said chest harness portion;
said oxygen muzzle including:
a first auxiliary reservoir containing oxygen coupled to said saddle portion and in fluid communication with said tubing so as to push oxygen toward said at least one outlet port when actuated;
a second auxiliary reservoir containing oxygen coupled to said chest harness portion and in fluid communication with said tubing so as to push oxygen toward said at least one outlet port when actuated.
